(19) United States
(12) Patent Application Publication
(10) Pub. No.: US 2005/0135239 A1
(43) Pub. Date: Jun. 23, 2005

(54) Autonomic optimization of wireless local area networks via protocol concentration

(75) Inventors: Daryl Carvis Cromer, Apex, NC (US); Philip John Jakes, Durham, NC (US); Howard Jeffrey Locker, Cary, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/741,071

(22) Filed: Dec. 19, 2003

(51) Int. Cl. H04L 1/00

(52) U.S. Cl. 370/229

(57) ABSTRACT

A wireless network access point is described which provides the resources of a backbone network to wireless clients. The access point optimizes wireless local area network traffic by concentrating access point traffic toward a single protocol. In the example given, 802.11g clients are associated upon request. However, when an 802.1lb client initiates a first association request, the association is deferred. That 802.11b client will tend to seek access to the backbone network through association with another access point. However, should a second association request be received by the same 802.11b client, the client is associated in response to the second association request. Specific time limits can be imposed relative to the second association request.

### BACKGROUND OF THE INVENTION

This invention pertains to wireless networking systems and, more particularly, to a wireless network access point which optimizes wireless local area network traffic by concentrating access point traffic toward a single protocol.

Within the past two decades, the development of raw computing power coupled with the proliferation of computer devices has grown at exponential rates. This phenomenal growth, along with the advent of the Internet, has led to a new age of accessibility to other people, other systems, and to information.

The simultaneous explosion of information and integration of technology into everyday life has brought on new demands for how people manage and maintain computer systems. The demand for information technology professionals is already outpacing supply when it comes to finding support for someone to manage complex, and even simple computer systems. As access to information becomes omnipresent through personal computers, hand-held devices, and wireless devices, the stability of current infrastructure, systems, and data is at an increasingly greater risk to suffer outages. This increasing complexity, in conjunction with a shortage of skilled information technology professionals, points towards an inevitable need to automate many of the functions associated with computing today.

Autonomic computing is one proposal to solve this technological challenge. Autonomic computing is a concept to build a system that regulates itself much in the same way that a person's autonomic nervous system regulates and protects the person's body.

Within the past decade, there has been accelerated growth in portable computing to meet the demands of a mobile workforce. This voluminous mobile workforce has traditionally relied on a cable connection to a backbone network in order to have access to resources such as printers, e-mail servers, databases, storage, and even Internet connections. Within the past few years alone, the industry has seen rapid deployment of wireless local area networks which offer increased convenience over cable connections to backbone networks. In addition to convenience, wireless networks offer the ability to roam while maintaining a network connection.

Recently, a standard for wireless local area networks known as the IEEE 802.11 standard has been adopted and has gained acceptance among the industrial, scientific and medical communities. The IEEE 802.11 standard for wireless networks is a standard for systems that operate in the 2,400-2,483.5 MHz industrial, scientific and medical (ISM) band. The ISM band is available worldwide and allows unlicensed operation of spread spectrum systems. The IEEE 802.11 RF transmissions use multiple signaling schemes (modulations) at different data rates to deliver a single data packet between wireless systems.

In a wireless local area network, wireless clients obtain access to resources on the backbone network through the use of an access point. The backbone network is typically on a wired network, such as ethernet, but can also be a second wireless network or any combination thereof. When an access point provides connectivity to resources directly on a wired network, the access point will contain, amongst other things, a wired LAN interface, a bridge function, and a wireless LAN interface in order to bridge traffic between the wireless network and the wired network.

Most installations use wireless local area networks as an overlay to an existing ethernet (cabled or wired) network which serves as a backbone or provides access to a backbone and its resources. Typically, access points are provided at various locations to create continuous geographical coverage for the wireless network. Since 802.11 is limited to 30 meters in range and Ethernet is physically limited to 100 meters in length, office environments typically deploy several access points on different backbones. The various wireless access points are assigned to different wireless frequency spectra or channels to allow overlap between wireless ranges.

802.11b is a popular IEEE wireless networking standard that has emerged and provides the aforementioned advantages. The new standard, 802.11g, is emerging which provides the advantages of 802.11b at a higher throughput which is on the order of ethernet wired local area network speed. As currently defined, 802.11g networks are backward compatible to 802.11b networks.

A problem exists, however, in that 802.11b traffic severely impacts 802.11g performance. 802.11b impacts performance of an 802.11g network because 802.11b clients are not able to recognize 802.11g traffic which follows the standard CSMA/CA physical carrier-sense protocol to avoid collisions. To subjugate this limitation, 802.11b clients must utilize a request to send (RTS)/clear to send (CTS) virtual carrier-sense protocol to avoid collisions and to gain access to the channel for transmission. With only a few 802.11b users on an access point that supports both 802.11g and 802.11b traffic, overall throughput degrades such that any performance benefit of 802.11g disappears. A challenge found, however, is in mitigating the impact introduced to one protocol from another protocol on the same access point according to autonomic computing principles.

### SUMMARY of the INVENTION

It has been discovered that the aforementioned challenges are resolved by identifying which of two or more protocols the client conforms to. When it is determined that the client initiating a first association request conforms to a first protocol, the association of that client is deferred. That client will tend to seek access to the backbone network through association with another access point.

However, should a second association request be received by the client conforming to the first protocol whose first association request has been deferred, the client is associated in response to the second association request. As a result of deferring the association, the client may find an alternative access point. Thus, impact introduced to one protocol from another protocol on the same access point is minimized. Simultaneously, clients conforming to the first protocol which have no other access points available are eventually associated regardless.

In a specific embodiment, the interval between the first association request and the second association request by the client is taken into account.

### BRIEF DESCRIPTION of the DRAWINGS

Some of the purposes of the invention having been stated, others will appear as the description proceeds, when taken in connection with the accompanying drawings, in which:

FIG. 1 depicts a scenario in which the concepts of the present invention are advantageous;

FIG. 2 is a block diagram of an access point configured according to an embodiment of present invention;

FIG. 3 is a block diagram of a client configured according to an embodiment of the present invention;

FIG. 4 is a flow diagram depicting the logic exercised by the client of FIG. 3 in maintaining and/or establishing association with the access point of FIG. 2;

FIG. 5 is an illustration of the type of table that is maintained according to one embodiment of the present invention; and

FIG. 6 is a flow diagram showing the logic exercised by the access point of FIG. 2 according to an embodiment of the present invention.

### DETAILED DESCRIPTION of the ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in a specific embodiment,” and similar language throughout this specification may, but do not necessarily, all refer to the same embodiment.

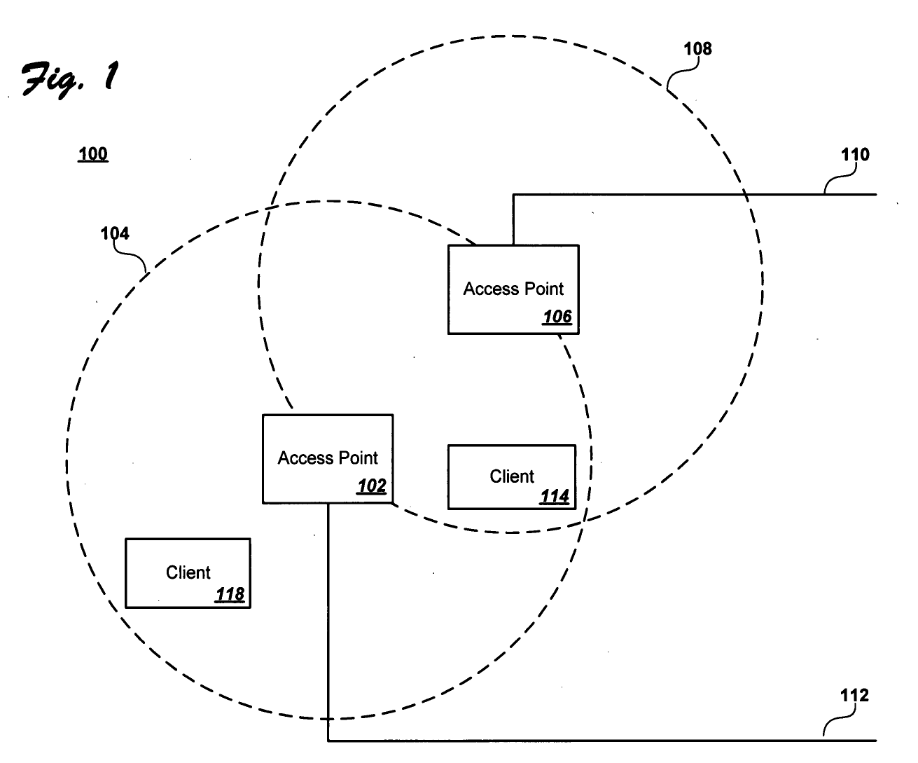

Referring now more particularly to the accompanying drawings, FIG. 1 depicts a scenario in which the concepts of the present invention are advantageous. Installation 100 consists of two access points 106 and 102 each having roughly circular geographical areas of coverage 108 and 104 respectively. Access points provide access to distributed resources and services via wireless medium for associated wireless clients or stations. Preferably, access points 106 and 102 contain IEEE 802.11 medium access control functionality and physical layer interface to the wireless medium. Wireless clients 114 and 118 are used here to represent a variety of wireless clients throughout installation 100. The wireless clients 114 and 118 are typically and preferably mobile computing units such as laptops and palmtops. As mobile units, clients 114 and 118 typically would not have printing capabilities nor other resources which would require hardware too large to hand carry. Such printing capabilities and other resources are found on backbone networks 110 and 112 which are coupled, according to installation 100, to two access points 106 and 102 respectively. Access points 106 and 102, in turn, provide the resources and services of the backbone network on to the wireless network in order to make the resources and services available to the wireless clients 114 and 118.

Backbone networks 110 and 112 provide installation 100 with the distributed resources and services. The resources and services include but are not limited to print servers and printers, e-mail servers, fax servers, database servers, and Internet access. Backbone networks 110 and 112 are preferably ethernet local area networks, optionally however, connections 110 and 112 can be wireless or optical distribution schemes to the same resources and services. In addition, backbone connections 110 and 112 can be bridge connections which in turn provide the resources and services of the backbone network.

Wireless clients 114 and 118 and are able to be configured in ad hoc mode and thereby engage in direct peer-to-peer data transfers and sharing of each other's resources when their respective signal strengths allow for direct connection. Otherwise, clients 114 and 118 are able reach each other through the backbone networks 110 and 112; in which case, their communications would be through the access points to which they are associated.

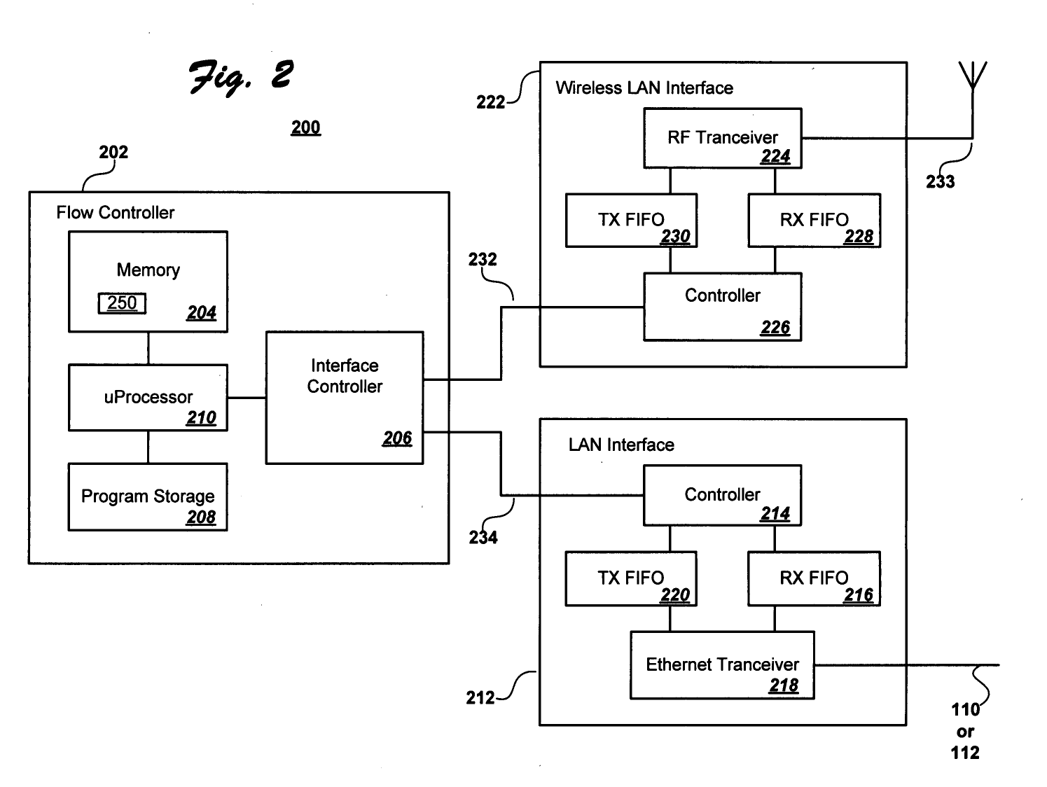

FIG. 2 is a block diagram of an access point configured according to an embodiment of present invention. Access point 200 includes wireless LAN interface 222, a bridge FIFO or flow controller 202, and a LAN interface 212. Wireless interface 222 can be any wireless interface using any wireless medium such as RF, infrared, VHF, UHF, and microwave. However, in the preferred embodiment, wireless LAN interface 222 is implemented as an 802.11compliant wireless local area network interface. LAN interface 212 can be a wired land-based network interface, an optical network interface such as a fiber-optic network interface, or even a second wireless network interface. However, in the preferred embodiment, LAN interface 212 is implemented as an interface for an ethernet land-based network. LAN interface 212 typically connects to or bridges to a backbone network which provides resources and services. Wireless LAN interface 222 provides the resources and services found on the backbone network to wireless clients which are associated to wireless LAN interface 222.

The term—association—as used herein refers to that service which is used to establish access point to client mapping and enable client invocation of the resources and services found on the backbone network.

Bridge FIFO/flow controller 202 bridges and controls the flow of traffic between wireless clients coupled through wireless LAN interface 222 and the backbone network coupled to LAN interface 212. Flow controller 202 maintains a FIFO buffer for bidirectional traffic between interfaces 222 and 212. Flow controller 202 can be implemented entirely in hardware, or partially in hardware and partially in software/firmware. In the preferred embodiment as shown in FIG. 2 however, flow controller 202 is implemented with a microprocessor 210 having program storage 208 which stores boot code and microcode for execution on a microprocessor 210. The boot code is typically executed directly from program storage 208 while the microcode is typically transferred to memory 204 for faster execution. Flow controller 202 also includes an interface controller 206 which performs the lower-level functions including handshaking functions required across interface 232 to the wireless LAN interface 222 and across interface 234 to the LAN interface 212.

The construction of wireless LAN interface 222 includes a physical layer RF transceiver 224, transmit and receive FIFO's 230 and 228 respectively, and a low-level controller 226 for interfacing to the flow controller via interface 232. Wireless LAN interface 222 includes an antenna 233 for coupling electromagnetic energy to the atmosphere. Notice that the term—RF—is used herein as to be consistent with the IEEE 802.11 specifications. Throughout the IEEE 802.11 specifications the direct sequence spread spectrum (DSSS) system therein described targets an RF LAN system having a carried frequency in the 2.4 GHz band designated for industrial, science, and medical (ISM) applications as provided in the USA according to FCC 15.247. In other words, the actual modulation frequencies used by the RF transceiver 224 are in the 2.4 GHz microwave ISM band rather than in the frequency band traditionally known as “RF.”

The construction of LAN interface 212 includes a physical layer ethernet transceiver 218, transmit and receive FlFO's 220 and 216 and a low-level controller 214 for interfacing to the flow controller via interface 234. Ethernet transceiver 218 is coupled to the backbone network 110 or 112.

Controller's 226 and 214 can be implemented in hardware, or as a combination of hardware and software/firmware components. In the preferred embodiment however, controllers 226 and 214 are implemented in hardware for faster operation.

Wireless LAN interface 222 and LAN interface 212 implement at least the physical and medium access control layers of the ISO LAN networking model. Higher ISO layers are implemented in the flow controller 202. However, it is possible to implement the higher layers of the ISO model in interfaces 222 and 212.

Further details concerning the construction and use of access point 200 shall be described in relation to the flow charts which follow. Certain details concerning the construction and use of access points are well known in the art and are omitted so as to not obfuscate the present disclosure in unnecessary detail.

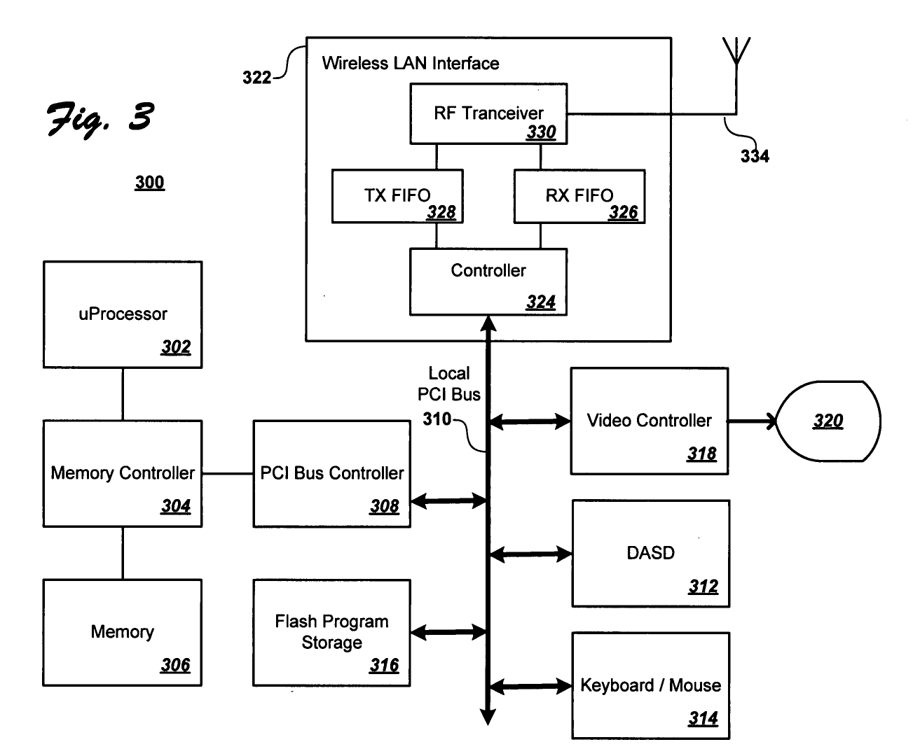

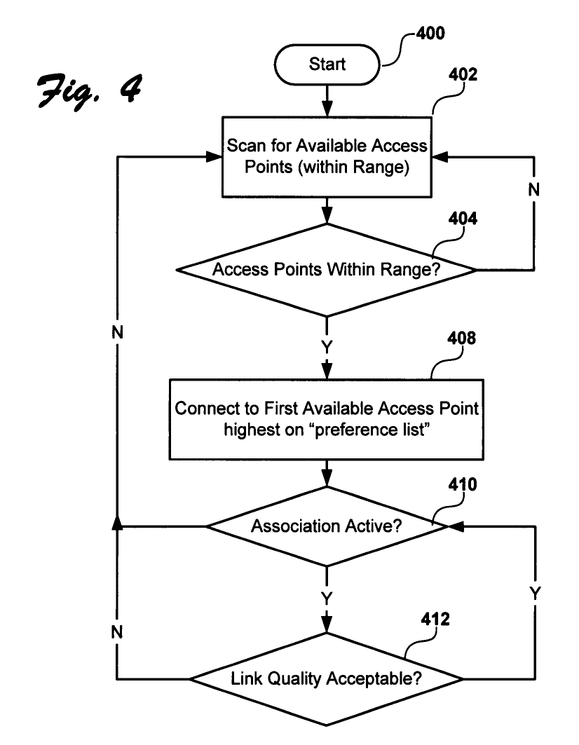

FIG. 3 is a block diagram of a client configured according to an embodiment of the present invention. The client 300 includes a physical layer RF transceiver 322, transmit and receive FIFO's 328 and 326 respectively, and a low-level controller 324 for interfacing to other components of client 300 through PCI bus 310. Wireless LAN interface 322 includes an antenna 334 for coupling electromagnetic energy to the atmosphere. Controller 300 further includes video controller 318 which provides control signals to video LCD display 320. PCI bus controller 308 operationally couples a variety of modules within client 300. A standard processing subsection is coupled to PCI bus controller 308 and consists of a microprocessor 302, a memory controller 304, and to memory 306. Microprocessor 302 receives its boot code from flash program storage 316 through PCI bus controller 308. A storage module 312 provides the client with DASD storage for storing application software and application data, and for storing and executing operating system code. Client 300 also includes a keyboard and mouse interface 314 which is coupled to PCI bus controller 308. Keyboard and mouse interface 314 accepts user input from a supplied keyboard and mouse. Establishing association and wireless connection to access point 200 according to the logic shown in FIG. 4, for which a detailed description shall be given in the description which follows, can be performed by controller 324 of wireless LAN interface 322 or by the microprocessor 302 and the controller 324. However in the preferred embodiment the association and wireless connection to access point 200 is implemented entirely in controller 324 according to logic depicted in FIG. 4.

FIG. 4 is a flow diagram depicting the logic exercised by the client of FIG. 3 in maintaining and/or establishing association with the access point of FIG. 2. Initially 400, client 300 scans 402 for any available access points with in its geographical range. A decision 404 is then made regarding whether access points are found. If none are found, client 300 continues to scan 402 for available access points. If one or more access points are found, client 300 will associate and connect 408 to the first available access point which is found to be highest on a predetermined preference list. The preference list can be entered by a user or entered automatically by system administrators through the network upon initial setup. A user would tend to enter, toward the top of list, the access points with which they have had the most success. Often, this is an access point closest to where the user normally physically resides and therefore, by virtue of its proximity to the user, provides the highest signal strength and gives the best signal quality. The client 300 then makes a two phase 410 and 412 determination as to the status of the association and link. First, a determination 410 is made as to whether the association remains active. If the association is not active, client 300 then continues to scan 402 for available access points. If the association is still active, client 300 then makes a determination 412 as to whether the link quality is acceptable. Link quality does not remain static for a variety of different reasons and therefore must be checked periodically. For example, if the client 300 is roaming, i.e., physically moving whether by public transit, automobile, or on foot, access point signal strength will diminish as the client moves away from the access point. Alternatively, link quality can degrade due to external electromagnetic interference. When it is determined 412 that the link quality is acceptable, client 300 maintains the association and proceeds to monitor the status 410 and the quality 412 of the connection. If it is determined 412 that the link quality is not acceptable, client 300 ventures out and scans 402 for alternative access points which might be available within its range in attempting to find a link with a higher level of signal quality.

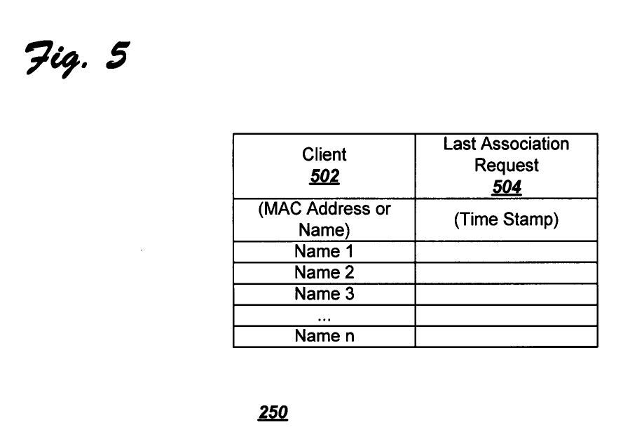

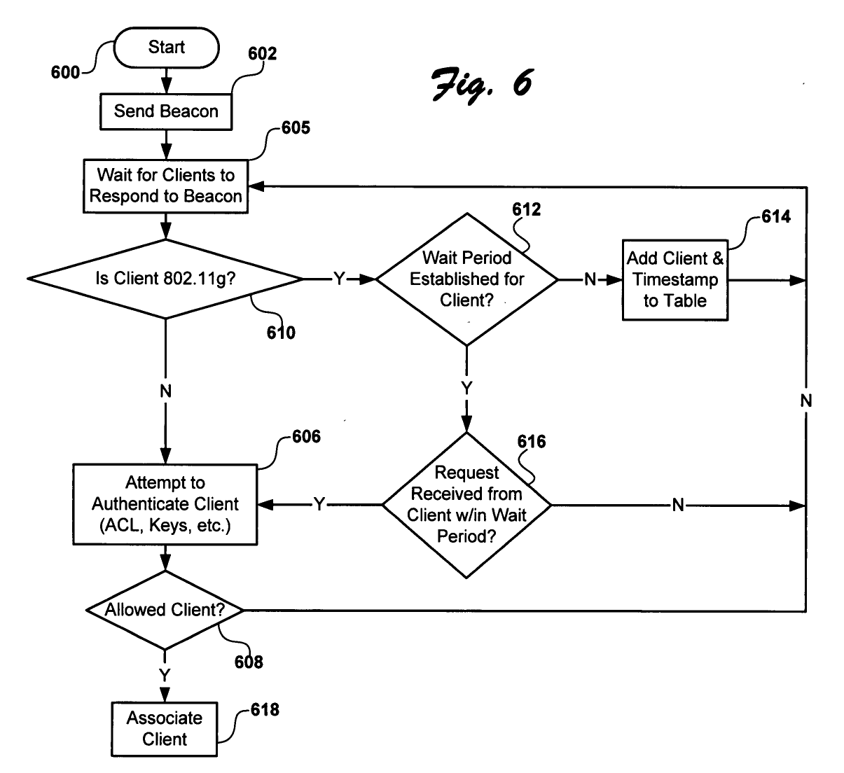

FIG. 5 is an illustration of the type of table that is maintained according to one embodiment of the present invention. Table 250 illustrated in FIG. 5 is maintained by access point 200 as an aid in determining which clients are to be associated. The logic to be described in relation to FIG. 6 utilizes the data variables stored in table 250 in making client association decisions. Table 250 is maintained in memory 204 of flow controller 202 found in FIG. 2.

Column 502 and column 504 of table 250 are reserved for maintaining a log of pending clients. As will be discussed in more detail in relation to the description of FIG. 6, column 502 of table 250 contains a unique identifier for the client which has issued an association request to access point 200 for access to the backbone. The unique identifier can be the name, the MAC address, or the IP address of the requesting client. Column 504 contains an entry representative of the point in time when the last beacon was received from a particular client. Alternatively, an entry which is representative of the point in time when the first beacon was received can be stored in column 504 of table 250. As another alternative, column 504 may contain an entry representative of that point in time when a first or a last beacon was received within a particular interval of time; this implementation is effective in discarding timestamps which are not within an interval of interest.

FIG. 6 is a flow diagram showing the logic exercised by the access point 200 of FIG. 2 according to an embodiment of the present invention. Referring now to FIG. 6 and to FIGS. 2 and 5, processor 210 of flow controller 202 maintain stable 250 in memory 204 of access point 200. Processor 210 maintains columns 502 and 504 for each client requesting access through access point 200. In the preferred embodiment, processor 210 of flow controller 202 executes the logic illustrated in FIG. 6. However, other embodiments are envisioned in which logic of FIG. 6 is executed entirely in hardware or alternatively in some combination of hardware and software or firmware. Execution begins 600 with the transmission 602 of a beacon identifying the availability of resources and services through access point 200. The beacon itself identifies the access point. Clients are preprogrammed to identify such beacons as providing availability to resources and services on the backbone. The access point then waits 605 for clients to respond to the beacons. When at least one client has responded to the beacon, a determination 610 is then made as to whether the client is an 802.11g compliant station. If it is determined 610 that the requesting client is not an 802.11g client, measures 612, 614, and 616 are taken in an effort to steer non 802.11g clients to other access points. If it is determined that the requesting client is an 802.11g client, measures 606, 608, and 618 are taken in associating the client in the usual manner. Measures 612, 614, and 616 are performed in the following manner when the determination 610 is that the requesting client is not an 802.11g client. First, it is determined 612 whether the client requesting access has an entry in column 502 of table 250. If the client does not have an entry, the client is added 614 to column 502 of table 250 as a pending client; in addition, a timestamp is added to column 504 indicating the time the request from the client was received. In this case, the client does not receive a response from the access point and the client is not associated. Instead of associating the client, access point 200 continues to wait 605 for clients to respond to the beacons. By deferring the non 802.11g client in this fashion, the non 802.11g client is incented to seek association with another access point. Should the non 802.11g client associate with another access point, mitigation of the impact introduced to one protocol from another protocol is achieved. If the second access point is following the same algorithm, the timestamp in the first access point will be earlier than timestamp in the second access point leading to the eventual client association to the first access point by virtue of the earlier timestamp in the first access point. However, should the client fail to find an alternative access point through which to connect to the backbone, the procedure which follows allows for the non 802.11g client to eventually associate. When it is determined 612 that the client does have an entry 502 in table 250, this indicates that the client has recently requested association by responding to a sent 602 beacon but has been denied a response. The return of this non 802.11g client indicates that no other access point has been found by the non 802.11g client. In the preferred embodiment, it is then determined 616 whether the timestamp entry 504 in table 250 indicates that the non 802.11g client has been delayed for at least a predetermined wait period. In other embodiments, no time is required and a second request to associate can be accepted. If 616 the time period has not been exceeded, the non 802.11g client is again not associated and access point 200 continues by waiting 605 for clients to respond to beacons. However, when it is determined 616 that the predetermined time period has been exceeded, the non 802.11g client is associated as per measures 606, 608, and 618.

Thus, an example will be now be given in accordance with the logic of FIG. 6 as executed by processor 210 of flow controller 202 of access point 200 in grouping 802.11g and non 802.11g traffic with different access points. Referring now to the scenario 100 given in FIG. 1, assume that clients 118 and 114 are 802.11b clients (i.e., non 802.11g) and neither are associated to any access point. Also, assume that both backbone's 110 and 112 are operational and that access point 102 operates according to the logic of FIG. 6 in attempting to associate 802.11g clients without delay while steering away non 802.11g clients. Further assume that access point 106 operates as a standard access point (or as an access point of FIG. 6 with the isolation feature disabled). According to the logic of FIG. 6, client 114 responds to beacons from both access points 102 and 106. Since access point 102 defers 802.11b Clients, an entry is made into table 250 for client 114 and the association of client 114 is deferred. Meanwhile, since access point 106 is a standard access point, access point 106 associates client 114 without delay. As a result of the association with access point 106, access point 102 will never receive a second response to a beacon. Mitigation of interference from disparate protocols has therefore been achieved on access point 102 with respect to client 114. With respect to client 118, client 118 will only hear a beacon from access point 102 and will respond accordingly. Access point 102 will defer the association of client 118 as described. Since client 118 has no other access point option, client 118 will continue to respond to beacons transmitted by access point 102, and eventually, the predetermined time period will be exceeded and client 118 will be associated to access point 102 even though access point 102 is an 802.11b client (is a non 802.11g client).

In the drawings and specifications there has been set forth a preferred embodiment of the invention and, although specific terms are used, the description thus given uses terminology in a generic and descriptive sense only and not for purposes of limitation.

1. Apparatus comprising:
a wireless network interface which supports a plurality of wireless protocols; and
a flow controller which is coupled to said wireless network interface and which receives a first association request provided by a client through said wireless network interface, identifies the client providing the request as a client which conforms to a first protocol, defers the association of the client in response to the first reception and in response to the identification, receives a second association request which is provided by the client, and associates the client in response to said second reception.

2. Apparatus of claim 1 wherein said flow controller associates the client if the interval between the first association request and the second association request exceeds a predetermined interval.

3. Apparatus comprising:
a wireless network interface which supports 802.11b and 802.11g wireless protocols; and
a flow controller which is coupled to said wireless network interface and which includes a processor and a memory for storing processor executable code, the code being effective when executing to:
receive a first association request provided by a client through said wireless network interface;
identify the client providing the request as a client which conforms to 802.11b protocol;
defer the association of the client in response to the first reception and in response to the identification;
maintain a table in the memory which includes first and second related entries, the first entry identifies the client making the association request and the second entry includes a timestamp which indicates the time of the first reception;
receive a second association request from the client;
determine whether the time of the second reception exceeds a predetermined interval by comparing the time of the second reception to the timestamp in the second entry which corresponds to the client; and
decide whether the client is to be associated based on the determination.

4. Apparatus of claim 3 wherein the decision is to associate the client responsive to the determination that the predetermined interval has been exceeded.

5. Apparatus of claim 3 wherein the decision is to refuse association of the client responsive to the determination that the predetermined interval has not been exceeded.

6. A method comprising:
receiving a first association request provided by a client on a wireless network which supports a plurality of wireless protocols;
identifying the client providing the request as a client which conforms to a first protocol;
deferring the association of the client in response to said first reception and in response to said identification;
receiving a second association request which is provided by the client; and
associating the client in response to said second reception.

7. The method of claim 6 wherein said association of the client is conditional and wherein the association depends on whether the interval between said first reception and said second reception exceeds a predetermined interval.

8. A method comprising:
receiving a first association request provided by a client on a wireless network wherein the wireless network which supports 802.11b and 802.11g wireless protocols;
identifying the client providing the request as a client which conforms to 802.11b protocol;
deferring the association of the client in response to said first reception and in response to said identification;
maintaining a table in memory which includes first and second related entries, the first entry identifies the client making the association request and the second entry includes a timestamp which indicates the time of said first reception;
receiving a second association request from the client;
determining whether the time of said second reception exceeds a predetermined interval by comparing the time of said second reception to the timestamp in the second entry which corresponds to the client; and
deciding whether the client is to be associated based on said determination.

9. The method of claim 8 wherein said decision is to associate the client responsive to said determination that the predetermined interval has been exceeded.

10. The method of claim 8 wherein said decision is to refuse association of the client responsive to said determination that the predetermined interval has not been exceeded.

11. A product comprising:
a computer usable medium having computer readable program code stored therein, the computer readable program code in said product being effective to:
receive a first association request provided by a client on a wireless network which supports a plurality of wireless protocols;
identify the client providing the request as a client which conforms to a first protocol;
defer the association of the client in response to said first reception and in response to said identification;
receive a second association request which is provided by the client; and
associate the client in response to said second reception.

12. The product of claim 11 wherein said association of the client is conditional and wherein the association depends on whether the interval between said first reception and said second reception exceeds a predetermined interval.

13. A product comprising:
a computer usable medium having computer readable program code stored therein, the computer readable program code in said product being effective to:
receive a first association request provided by a client on a wireless network wherein the wireless network which supports 802.11b and 802.11g wireless protocols;
identify the client providing the request as a client which conforms to 802.11b protocol;
defer the association of the client in response to said first reception and in response to said identification;
maintain a table in memory which includes first and second related entries, the first entry identifies the client making the association request and the second entry includes a timestamp which indicates the time of said first reception;
receive a second association request from the client;
determine whether the time of said second reception exceeds a predetermined interval by comparing the time of said second reception to the timestamp in the second entry which corresponds to the client; and
decide whether the client is to be associated based on said determination.

14. The product of claim 13 wherein said decision is to associate the client responsive to said determination that the predetermined interval has been exceeded.

15. The product of claim 13 wherein said decision is to refuse association of the client responsive to said determination that the predetermined interval has not been exceeded.
